(19) United States
(12) Patent Application Publication
(10) Pub. No.: US 2013/0188374 A1
(43) Pub. Date: Jul. 25, 2013

(54) MOTOR VEHICLE HEADLAMP

(71) Applicant: GM GLOBAL TECHNOLOGY OPERATIONS LLC, Detroit, MI (US)

(72) Inventors: Ingolf SCHNEIDER, Ruesselsheim (DE); Carsten STEINKAEMPER, Bad Schwalbach (DE); Frank LANGKABEL, Ruesselsheim (DE)

(73) Assignee: GM GLOBAL TECHNOLOGY OPERATIONS LLC, Detroit, MI (US)

(21) Appl. No.: 13/745,209

(22) Filed: Jan. 18, 2013

(30) Foreign Application Priority Data
Jan. 19, 2012 (DE) 102012001009.5

(51) Int. Cl. B60Q 1/08

(52) U.S. Cl. CPC B60Q 1/08
USPC 362/465

(57) ABSTRACT

A method for controlling a headlamp of a motor vehicle and a motor vehicle having a control means for performing the method are provided. The method includes automatically changing a light-related variable of the headlamp in a stationary state-driving state of the motor vehicle.

### CROSS-REFERENCE TO RELATED APPLICATION

This application claims priority to German Patent Application No. 102012001009.5, filed Jan. 19, 2012, which is incorporated herein by reference in its entirety.

### TECHNICAL FIELD

The technical field relates to a method for controlling a headlamp of a motor vehicle and to a motor vehicle headlamp and a motor vehicle having a control means that is equipped for carrying out such a method.

### BACKGROUND

Motor vehicle headlamps impart different vehicle lighting functions, for example a low beam or a high beam function. To this end, different headlamps are usually provided. From DE 102 05 779 A1 it is known to individually switch on and switch off or dim light-emitting diodes of a headlamp for a motor vehicle in order to realize different vehicle lighting functions such as low beam and high beam functions through the same headlamp.

In the same vehicle lighting function operating mode the headlamp is always operated the same in this case. Thus, the headlamp, for example in low beam operating mode shines so bright that it adequately illuminates the surroundings in front of the motor vehicle even with poorer visual conditions in order to make possible a safe driving. A headlamp with a correspondingly high-intensity illumination on the other hand can impair persons in the cone of light of the headlamp although with the vehicle being stationary, less brightness would be required. For example, the occupants of a motor vehicle standing opposite or of a motor vehicle standing directly in front can be impaired through headlamps of a motor vehicle stopping at a traffic light. In particular during the night, so-called afterimages can occur.

At least one object herein is to make available an improved motor vehicle. In addition, other objects, desirable features and characteristics will become apparent from the subsequent summary and detailed description, and the appended claims, taken in conjunction with the accompanying drawings and this background.

### SUMMARY

Various embodiments contemplated herein relate to the controlling of a headlamp, in particular of a headlamp, of a motor vehicle, wherein a controlling in this case is to mean a regulating as well. In an exemplary embodiment, a headlamp can comprise one or more light sources, in particular light-emitting diodes, LEDs. In another embodiment, the headlamp comprises a plurality of arrangements of one or more light sources each arranged spaced from one another on the motor vehicle, in particular light-emitting diodes, for example a high beam light and a low beam light as well a fog lamp arrangement spaced from these, each with one or more light sources. For the more compact realization, such a distributed arrangement is also described as a headlamp. The motor vehicle can be a passenger car, utility vehicle, off-road vehicle and/or commercial vehicle.

In an exemplary embodiment, a light-related variable of the headlamp in a stationary vehicle state of the motor vehicle is automatically changed through a control means, for example, in a predetermined manner. A stationary vehicle state as contemplated herein can be characterized in that a speed of the vehicle is below a predetermined limit value, for example the vehicle—at least substantially—being stationary.

In that a light-related variable of a headlamp changes upon vehicle stoppage, for example is reduced, the effect of the headlamp can be adapted. Thus in an embodiment during a prolonged stop, for example at a traffic light, a brightness of a headlamp can be reduced and thus an impairment of an occupant of a motor vehicle standing opposite or immediately in front, but also of pedestrians, can be reduced.

A light-related variable can be a radiation variable, which preferentially describes an energy, in particular a radiant flux Φₑ [W], irradiation Hₑ [J/m²], radiation intensity Eₑ [W/m²], radiation intensity Iₑ [W/sr], specific radiance Mₑ [W/m²] or radiation density Lₑ [W/(sr m²)]. Equally, a light-related variable can be a photometric variable, which preferentially describes a brightness perception of the visible light irradiated from the headlamp, for example a light intensity I [cd], light density L [cd/m²], specific light radiance M [lm/m²], light quantity Q [lm s], illumination intensity E [lx], exposure H [lx s] or a light current Φ [lm].

A light-related variable can be reduced or increased in particular by a predetermined percentage rate or absolute amount. For example, in the case of a headlamp having one or more light sources, in particular LEDs, one or more light sources can be dimmed, switched off or on.

In an exemplary embodiment, a light-related variable can be changed, for example reduced, by a change of an energy supply of the headlamp. In another embodiment, a voltage, for example a constant voltage, with which the headlamp is supplied, can be changed, for example reduced. Additionally or alternatively, a voltage can be changed, in particular reduced in a pulse width controlled manner or through a variation of voltage supply and voltage omission. If a headlamp comprises a plurality of light sources, such as LEDs, an energy supply of individual light sources can be differently changed in an embodiment. Additionally or alternatively, the energy supply of groups of light sources, in particular of all light sources of the headlamp jointly, can be changed. Advantageously, a change, in particular reduction of an energy supply can also save energy.

Additionally or alternatively to a change of an energy supply, one or more optical characteristics of the headlamp can be changed. For example, shades, reflectors, lenses or the like can be adjusted individually, by groups or jointly and thus for example a beam path of the headlamp changed.

In addition or alternatively, a position, i.e. position and/or orientation of the headlamp relative to the motor vehicle can be changed, for example one or more light sources pivoted.

Based on an irradiation surface of the headlamp and/or for example a standardized receiving surface, such as a perpendicular wall in front and/or laterally next to the motor vehicle—a light-related variable can be changed—at least substantially—uniformly. In that for example a constant voltage, with which the headlamp is supplied, is reduced, a radiant flux is substantially reduced homogenously. Equally, in another embodiment, the light-related variable can also be changed differently by regions. In particular, in an embodiment, different light sources of the headlamp can be differently activated, for example, dimmed or switched off

In a further embodiment, a light-related variable is changed dependent on a stoppage time of the motor vehicle. For example, a light-related variable can be reduced upon a predetermined time duration or since a predetermined event has elapsed, for example, since the motor vehicle, at least substantially, is stationary.

Additionally or alternatively, a light-related variable can be changed dependent on a brake actuation of the motor vehicle. For example, a light-related variable can be reduced for as long as a brake of the motor vehicle is actuated. In particular, when a light-related variable is reduced, as soon as the vehicle is stationary for a predetermined time duration and for as long as a brake of the motor vehicle is actuated, a low-beam, fog and/or daytime for example on traffic lights can be reduced.

Additionally or alternatively, a light-related variable can be changed dependent on a surrounding condition. A surrounding condition can be or comprise an ambient brightness and/or a visual condition, for example. In another embodiment, a light-related variable can be changed when an ambient brightness corresponds to daytime, dusk/dawn or twilight, non-illuminated night, slightly illuminated surroundings, for example a street illuminated by street lighting, greatly illuminated surroundings, for example illuminated motor vehicle, or the like. For example, a light-related variable of a headlamp can be reduced when the motor vehicle stands at an illuminated traffic light or in similar ambient brightness. Different visual conditions, which—likewise cumulatively with further conditions if applicable—can require a change of a light-related variable, can for example be clear vision, (light or heavy) rain, fog, snow fall or the like.

Additionally or alternatively, a light-related variable can be changed dependent of a position relative to a further motor vehicle.

In a further embodiment, a position of the motor vehicle relative to a further motor vehicle, for example, a motor vehicle standing directly in front of or opposite can be determined for example through distance measuring means, such as distance sensors, preferentially radar, infrared, and/or ultrasound sensors, image means, in particular ambient, preferentially reversing cameras, direct or indirect communication between vehicles, their navigation systems, mobile communication means of their occupants such as mobile telephones, or the like.

Dependent on a position relative to a further motor vehicle, a light-related variable of the headlamp can then be changed. Thus, for example a brightness of a headlamp can be reduced when it is sensed that a further vehicle is directly standing in front of the motor vehicle.

Additionally or alternatively a light-related variable can be changed dependent on a geographical variable.

In another embodiment, a position of the motor vehicle relative to a geographical surroundings can be determined for example through distance measuring means, in particular distance sensors, for example, radar, infrared and/or ultrasound sensors, image means, for example, surroundings cameras, such as reversing cameras, a navigation system or the like. In a further embodiment, a light-related variable can be changed dependent on whether the motor vehicle is located on a highway or main road and/or outside or within a built-up area, i.e. in urban traffic, or the like. Then, a brightness of a headlamp can be reduced, for example, when it is sensed that the motor vehicle is stopping within a built-up area, in particular on a traffic light.

In an embodiment, the change of the light-related variable can be adjusted by a vehicle occupant. In another embodiment, a percentage rate or an absolute amount of a change can be selected. In this manner a driver for example can decide if he wishes a reduction of a brightness of a headlamp after a predetermined stoppage time at a traffic light or not.

In a further embodiment, the headlamp comprises one or a plurality of vehicle illumination function operating modes. A vehicle illumination function operating mode, for example, can be a stationary light operating mode with which the headlamp acts as preferentially white stationary light in order to indicate the parked motor vehicle even with switched-off ignition. In particular, a stationary light operating mode can be a parking light operating mode, with which only one of two lateral light source arrangements acts as preferentially white stationary light in order to indicate an in particular road-facing side of the parked motor vehicle. Alternatively or in a further vehicle illumination function operating mode, the headlamp can act as low beam light in order to illuminate a surroundings, in particular in front of, next to and/or behind the motor vehicle. Alternatively or in a further vehicle illumination function operating mode, the headlamp can act as daytime or city driving light in order to indicate the vehicle to oncoming traffic, wherein a light-related variable can be smaller compared with a low beam operating mode. Alternatively or in a further vehicle illumination function operating mode, the headlamp can act as high beam in order to further illuminate a surroundings, in particular in front of, next to and/or behind the motor vehicle than in a low beam operating mode, with which conversely—in contrast with the high beam operating mode, a dazzling of oncoming traffic is reduced, in particular a part of the headlamp can be shaded. Alternatively or in a further vehicle illumination function operating mode, the headlamp can act as fog light in order to illuminate a surroundings, in particular in front of, next to and/or behind the motor vehicle even with fog. In particular, a cone of light of the headlamp can be positioned differently compared with a low beam light in order to reduce a reflection on fog droplets.

In an exemplary embodiment, a light-related variable of the headlamp is changed through a control means automatically, for example in a predetermined manner in at least one vehicle illumination function operating mode. If the headlamp has more than one vehicle illumination function operating mode, for example a low beam light and a high beam light operating mode, a light-related variable of the headlamp can be changed in a vehicle illumination function operating mode. In one or more further vehicle illumination function operating modes, the same and/or another light-related variable can be changed. Here, the same light-related variable can be changed in the same way in different vehicle illumination function operating modes, for example reduced by the same percentage rate or absolute amount. Equally, the same light-related variable can also be differently changed in different vehicle illumination function operating modes, for example reduced by different percentage rates or absolute amounts. In particular, it can also be provided that only in one of more than one vehicle illumination function operating modes a light-related variable is changed.

A means in the sense contemplated herein, in particular a control, sensing and/or changing means, can in particular be designed as hardware- and/or software-based and/or comprise a storage and/or processing unit and/or a program or program module.

### BRIEF DESCRIPTION OF THE DRAWINGS

The various embodiments will hereinafter be described in conjunction with the following drawing figures, wherein like numerals denote like elements, and wherein:

FIG. 1 is a headlamp and a control means of a motor vehicle according to an exemplary embodiment; and

FIG. 2 is a method for controlling the headlamp of FIG. 1 according to an exemplary embodiment.

### DETAILED DESCRIPTION

The following detailed description is merely exemplary in nature and is not intended to limit the various embodiments or the application and uses thereof Furthermore, there is no intention to be bound by any theory presented in the preceding background or the following detailed description.

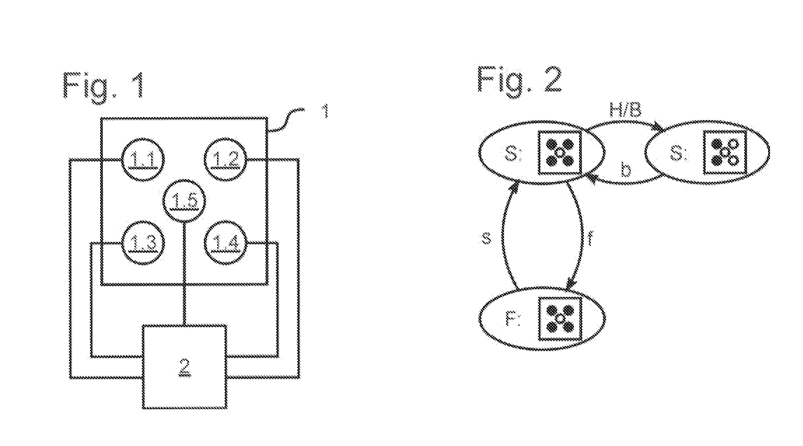

In accordance with an exemplary embodiment, FIG. 1 shows a headlamp in the form of a combined low-beam and high-beam headlamp 1 having five light sources in the form of LEDs 1.1 to 1.5, which can be individually activated by a control means in the form of a control electronic device 2.

FIG. 2 shows in the form of an automatic status device the sequence of a method for controlling the headlamp 1 in accordance with an exemplary embodiment, which method is carried out by the control means 2.

In FIG. 2 bottom left, a moving driving state F of the vehicle is shown: with low beam light switched on, the headlamp 1 in normal driving mode is to illuminate the surroundings in front of the motor vehicle in a low-dazzle or dazzle-free way. To this end, the control means 2 activates the four LEDs 1.1 to 1.4 (see FIG. 1) which in FIG. 2 are filled in dark at the bottom left. In a high beam operating mode (not shown), the central LED 1.5 is additionally activated.

From this moving driving state, the motor vehicle can change into a stationary driving state S through complete braking (FIG. 2: “s”), which is represented at the top in FIG. 2. Here, the four outer LEDs 1.1. to 1.4 initially remain activated (see FIG. 2 top left), i.e. the low beam light remains unchanged.

In an embodiment, when the control means 2 determines that since the reaching of the stationary state-driving state S a predetermined stationary state time H has elapsed and the driver continues to actuate a brake (FIG. 2: “B”), the control means 2 automatically changes a light-related variable of the headlamp 1, in that it interrupts the energy supply of the two inside LEDs 1.2, 1.4. Because of this, the radiant flux Φₑ, an irradiation He of a perpendicular wall in front of the motor vehicle (not shown) and the light current Φ.

When the actuation of the brake (FIG. 2: “b”) is omitted, the control means 2, re-activates the two inside LEDs 1.2, 1.4. Following this, the motor vehicle can drive off again (FIG. 2: “f”), i.e. change into the moving vehicle state F.

In this way, the brightness of the headlamp can be reduced during a traffic light stop and an impairment of vehicles or pedestrians standing opposite and an energy consumption of the headlamp can be reduced, while in the moving driving state the brighter low beam light is available. The driver can again command the full low beam light in the stationary state and after the elapsing of the predetermined stationary state time H in that he terminates the brake actuation (FIG. 2: “B”→“b”).

In the preceding description, exemplary embodiments were explained, it is pointed out that a multiplicity of modifications is possible.

Through the selective switching on and switching off of individual LEDs 1.1 to 1.5, the mentioned light-related variables in particular are changed differently in regions. Additionally or alternatively to a switching-on and switching-off, a dimming of individual or of all LEDs 1.1 to 1.5 can also be provided in a preferred embodiment, which in particular can offer the advantage of a continuous changing possibility.

In the exemplary embodiment, the reduction of the low beam light in the stationary state depends on that cumulatively both the predetermined stationary state time H has elapsed as well as the brake is actuated (FIG. 2: “B”). In a modified embodiment, the reduction of the low beam light can also take place only dependent on the elapsing of the predetermined stationary state time H independently of whether the brake is actuated. Additionally or alternatively, the change, in particular reduction, can also depend on whether the motor vehicle is located within or outside built-areas, on the magnitude of an ambient brightness and the like. Thus, the reduction shown in FIG. 2 for example in the stationary state can be carried out in a modification only then, when in addition to the elapsing of the predetermined stationary state time H the vehicle is located within a built-up area (which for example can be determined through a navigation system), a further vehicle is standing directly in front of the stationary vehicle (which can be determined for example through a distance sensing means), and/or a night-ambient brightness.

In the control means 2, a time sensing means for sensing a stationary state time H of the motor vehicle and a changing means for changing an energy supply is implemented.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for controlling a headlamp of a motor vehicle, the method comprising the steps of:
automatically changing a light-related variable of the headlamp in a stationary state-driving state of the motor vehicle.

2. The method of claim 1, wherein automatically changing comprises automatically reducing.

3. The method according to claim 1, wherein the light-related variable is changed dependent on a stationary state time of the motor vehicle and/or of a brake actuation and/or dependent on an ambient condition.

4. The method according to claim 3, wherein the light-related variable is changed dependent on an ambient brightness and/or a visual condition.

5. The method according to claim 1, wherein automatically changing comprises automatically changing the light-related variable dependent on a position relative to a further motor vehicle and/or a geographical variable.

6. The method according to claim 5, wherein the position is determined relative to the further motor vehicle by means of an image means, a distance measuring means, a navigation means and/or a communication means.

7. The method according to claim 1, wherein the light-related variable is changed differently by regions.

8. The method according to claim 1, wherein a change of the light-related variable is adjustable.

9. The method according to claim 1, wherein the light-related variable is changed through a change of an energy supply, optical characteristic and/or position of the headlamp relative to the motor vehicle.

10. The method according to claim 1, wherein the light-related variable of the headlamp is changed differently in a vehicle illumination function operating mode.

11. The method according to the claim 10, wherein the vehicle illumination function operating mode is a parking light, daytime or city driving light, low beam light, fog light and/or high beam light operating mode.

12. The method according to claim 1, wherein the light-related variable of the headlamp is changed differently in different vehicle illumination function operating modes.

13. The method according to claim 1, wherein automatically changing the light-related variable comprises automatically changing a radiation variable and/or photometric variable.

14. A motor vehicle comprising:
a headlamp; and
a control means configured to automatically change a light-related variable of the headlamp in a stationary state-driving state of the motor vehicle.

15. The motor vehicle according to claim 14, wherein the headlamp comprises at least one light emitting diode.

16. The motor vehicle according to claim 14, wherein the control means comprises a time sensing means for sensing a stationary state time of the motor vehicle, an ambience condition sensing means for sensing an ambient condition, a position sensing means for sensing a position relative to a further motor vehicle and/or to a geographical variable, and/or a changing means for changing an energy supply, optical characteristic and/or a position of the headlamp relative to the motor vehicle.
